(19) United States
(12) Patent Application Publication
(10) Pub. No.: US 2025/0132637 A1
(43) Pub. Date: Apr. 24, 2025

(54) AXIAL BRUSHLESS MOTOR GENERATOR

(71) Applicants: Richard Christopher Uskert, Timonium, MD (US); Amanda Kay McGrail, Owings Mills, MD (US); David Daniel Billingsley, Seven Valleys, PA (US)

(72) Inventors: Richard Christopher Uskert, Timonium, MD (US); Amanda Kay McGrail, Owings Mills, MD (US); David Daniel Billingsley, Seven Valleys, PA (US)

(21) Appl. No.: 18/922,059

(22) Filed: Oct. 21, 2024

Related U.S. Application Data
(60) Provisional application No. 63/591,545, filed on Oct. 19, 2023.

(51) Int. Cl. H02K 7/18; F01D 5/06; F01D 5/14; H02K 16/02

(52) U.S. Cl. CPC H02K 7/1823; F01D 5/06; F01D 5/147; H02K 16/02; F05B 2220/706; F05B 2240/372; F05B 2260/404

(57) ABSTRACT

The specification describes an electromagnetic propulsive motor having a rotor capable of rotation around a shaft and having a plurality of radially disposed blades including blade tip portions for compressing a working fluid. A stator having a case frame and a plurality of radially disposed vanes extending generally between the case frame and the shaft direct the working fluid. A plurality of electromagnetic elements disposed within the rotor blades proximate the tip portions thereof interact electromagnetically with a plurality of electromagnetic elements disposed in the stator case frame to drive the rotor.

### CROSS-REFERENCE TO RELATED APPLICATIONS

This application claims the benefit of U.S. Provisional Patent Application No. 63/591,545, filed Oct. 19, 2023.

### FIELD OF THE INVENTION

The present invention relates generally to turbine systems, and more particularly to an electromagnetically driven axial brushless power generation or motor system.

### BACKGROUND OF THE INVENTION

Modern gas turbine engines employ a fan to draw in a working fluid, typically air, a compressor to compress the working fluid entering the engine, a combustor to burn the compressed air mixed with fuel, and a turbine that extracts work from the working fluid exiting the engine by driving a shaft or a bypass fan, or both. In some prior art commercial gas turbine engines the bypass fan supplies are larger portion of the thrust of the engine, while in some military engine applications more thrust is provided by the compressor and turbine sections. Each of the aforementioned engine sections is typically comprised of one or more stages of rotating blades and concomitant static or non-rotating vanes to direct the working fluid and extract work from the hot combusted gases in order to drive the compressor and fan, thus providing an exhaust gas stream of high velocity (“jet propulsion”) to generate a propulsive force typically employed in aircraft flight.

Many gas turbine engines produce large amounts of thrust but are typically costly to operate and manufacture due to the need to burn large quantities of jet fuel to drive the turbine. Additionally, the pollutants produced as a byproduct of jet fuel combustion, for example carbon dioxide and other combustion products of hydrocarbons, are highly undesirable. Since the gas passing through the engine aft of the combustor is quite hot, all engine components are subjected to tremendous heat and thermal stresses, and thus must be made from materials suitable to withstand extreme heat. Furthermore, the rotating components of a gas turbine engine have very high rotational velocities, that, when coupled with thermal expansion and impacts caused by normal engine operation cause them to rub or interfere with the static portions of the turbine. These inherent features of modern gas turbines render them quite costly to produce, as all components must be produced to extremely tight tolerances and be capable of withstanding enormous thermal and mechanical stresses.

Additionally, many prior art rotor and stator assemblies are quite complex, having a multiplicity of parts required to render the assembly capable of containing a high-pressure air stream and operate under a wide variety of power, speed, and atmospheric conditions. The cost and complexity of designing and constructing such prior art assemblies is quite prohibitive.

The present embodiments provide an improvement to the prior art by providing an axial brushless motor by replacing the combustor and turbine sections of a conventional gas turbine engine with one or more electromagnetically driven compressive stages in order to provide a high velocity gas stream for propulsion while enhancing the operating efficiency of the propulsion system and eliminating the combustion of fossil fuels from operation of the engine.

### SUMMARY OF THE INVENTION

The various embodiments disclose an electromagnetic propulsive motor for an aircraft, vehicle, or power generation. More specifically the embodiments described herein relate to an axial brushless motor and/or generator for compressing a working fluid. The motor may include metallic, ceramic and/or composite rotor and stator structures as components of at least one rotor stage and a stator. The motor of the present invention utilizes a novel rotor and stator design having a stator case frame incorporating a plurality of electromagnetic elements or drives secured thereto for interaction with a plurality of rotor stages having magnetic or electromagnetic elements arranged for electromagnetic interaction with the stator. A controller is provided to manage and control the electromagnetic power being supplied to stator and rotor, and to monitor and control all aspects of motor operation.

The motor may include at least one rotor stage, or a plurality thereof, and further includes a plurality of novel rotor blades, each comprising a magnetic or electromagnetic element disposed at a radially outward portion of the blades to interact with the electromagnetic elements positioned in the stator case frame. As the rotor blades spin around a central axial shaft, the electromagnetic elements positioned on the rotor blades alternately repulse and attract complementary elements positioned on the stator case frame.

Furthermore, a variety of magnetic and electromagnetic elements disposed in an outer ring of the rotors interact with a variety of stator mounted electromagnetic elements. Additionally, a novel arrangement of rotor bearing surfaces are provided to engage concomitant stator-mounted bearings to guide and stabilize the rotor as it is electromagnetically driven.

The controller may include a processor, concomitant data memory, signal inputs and outputs, and a suitable instruction set to supply a plurality of output signals to operate various motor systems and energize and control the stator electromagnetic elements. The controller also includes a plurality of signal inputs that are operatively coupled to speed, pressure and temperature sensors disposed at various locations throughout the motor to monitor operation of the plurality of rotor/stator stages of the motor. By timing the field polarity and strength of the field created by the electromagnetic elements, the rotor stages can be driven at any required speed or power output level desired.

The principles and concepts embodied herein may also be employed with a turbofan engine, for example a bypass fan motor configuration. Furthermore, the rotor and stator electromagnetic element interaction can be utilized as a generator of electrical power where the rotor is spinning freely and is not required to be driven.

The various embodiments also comprise a plurality of rotor configurations, each including a magnetic or electromagnetic element arranged proximate an outer ring of the rotor and positioned to interact with a concomitant stator-mounted element. The rotor stages may also include a plurality of bearing surfaces arranged at various locations and angles that contact concomitant stator mounted bearing surfaces to guide and orient the rotor as it is driven by the applied electromagnetic fields supplied by the controller. Furthermore, the rotor assemblies may be integrally bladed, wherein the rotor outer ring, inner ring, and blades all comprise a unitary structure.

Other features, objects, and advantages of the present invention will become readily apparent from the detailed description of the preferred embodiments taken in conjunction with the attached drawing Figures.

### BRIEF DESCRIPTION OF THE DRAWING FIGURES

FIG. 1 is a perspective view of an axial electromagnetic motor in accordance with some embodiments;

FIG. 2 is a perspective view of an axial electromagnetic motor in accordance with some embodiments;

FIG. 3 is a partial cross-sectional perspective view of an axial electromagnetic motor in accordance with some embodiments;

FIG. 4 is a partial cross-sectional perspective view of an axial electromagnetic motor in accordance with one embodiments;

FIG. 5 is a partial cross-sectional perspective view of an axial electromagnetic motor in accordance with some embodiments;

FIG. 6 is a partial cross-sectional perspective view of an axial electromagnetic motor in accordance with one embodiment of the present invention;

FIG. 7 is a partial cross-sectional perspective view of an integrally bladed rotor in accordance with some embodiments;

FIG. 8 is a partial cross-sectional perspective view of a rotor assembly in accordance with some embodiments;

FIG. 9 is a partial cross-sectional perspective view of a rotor assembly in accordance with some embodiments;

FIG. 10 is a partial cross-sectional perspective view of a rotor assembly in accordance with some embodiments;

FIG. 11 is a partial cross-sectional perspective view of a rotor assembly in accordance with some embodiments;

FIG. 12 is a partial cross-sectional perspective view of a rotor assembly and control scheme in accordance with some embodiments;

FIG. 13 is a partial cross-sectional perspective view of a multi-stage rotor assembly and control scheme in accordance with some embodiments;

FIG. 14 is a partial cross-sectional perspective view of a multi-stage rotor assembly and control scheme in accordance with some embodiments;

FIG. 15 is a partial cross-sectional perspective view of a multi-stage rotor assembly and control scheme in accordance with some embodiments;

FIG. 16 is a partial cross-sectional perspective view of a multi-stage rotor assembly and control scheme in accordance with some embodiments;

FIG. 17 is a partial cross-sectional perspective view of an a multi-stage rotor assembly and control scheme in accordance with some embodiments;

FIG. 18 is a partial cross-sectional perspective view of a stator case and electromagnetic element assembly in accordance with some embodiments;

FIG. 19 is a block diagram of a control scheme for an axial electromagnetic motor in accordance with some embodiments;

FIG. 20 is a block diagram of a rotor control scheme for an axial electromagnetic motor in accordance with some embodiments;

FIG. 21 is a partial cross-sectional perspective view of a stator and rotor assembly in accordance with some embodiments; and

FIG. 22 is a partial cross-sectional perspective view of a bypass fan electromagnetic axial motor in accordance with some embodiments.

### DETAILED DESCRIPTION OF THE PREFERRED EMBODIMENT(S)

For the purpose of promoting an understanding of the principles of the embodiments and aspects described in the instant application reference will now be made to those embodiments illustrated in the drawing Figures, and specific language will be used to describe the same. It is nonetheless understood that no limitation of the scope of the various embodiments is intended by the illustrations and descriptions thereof. Additionally, any alterations and/or modifications of the illustrated and/or described embodiment(s) are contemplated as being within the scope of the present invention. Furthermore, any other applications of the principles of the various embodiments, as illustrated and/or described herein, as would normally occur to one skilled in the art to which the invention pertains, are contemplated as being within the scope of the present invention.

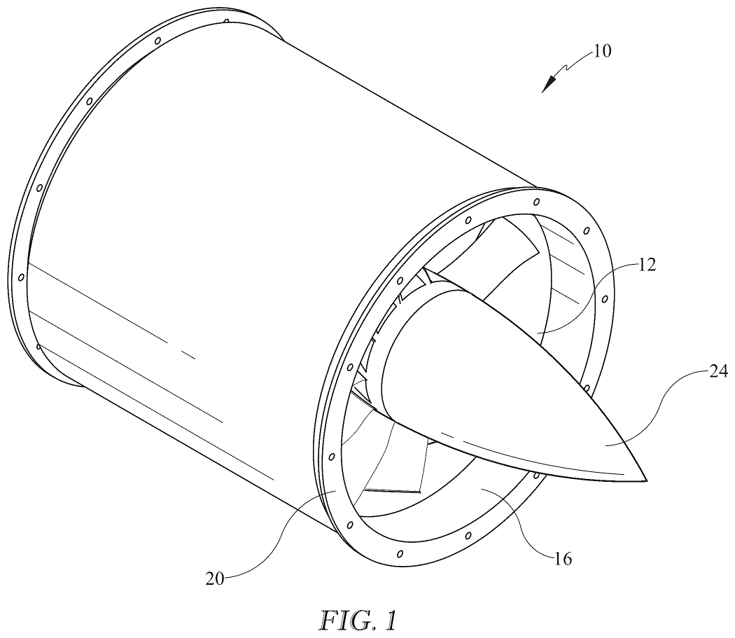

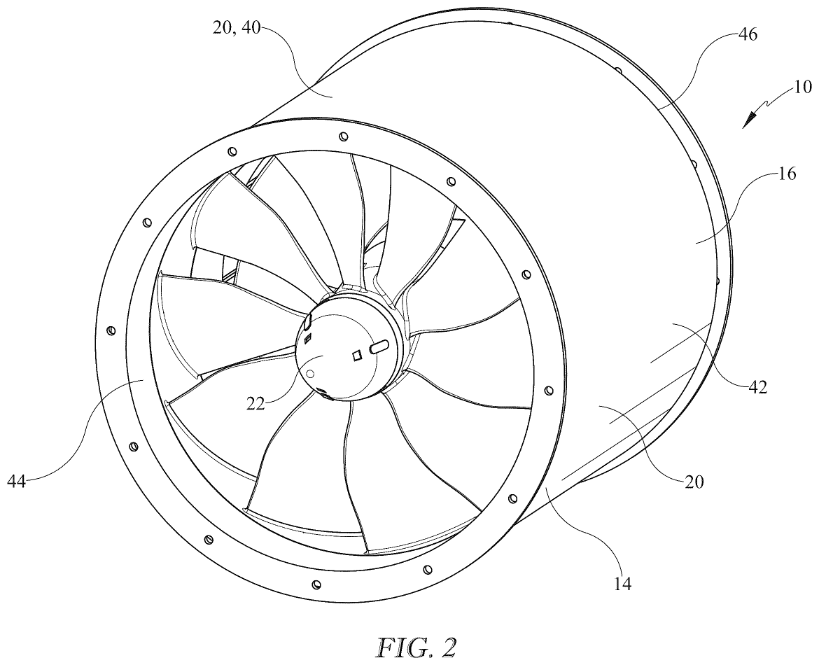

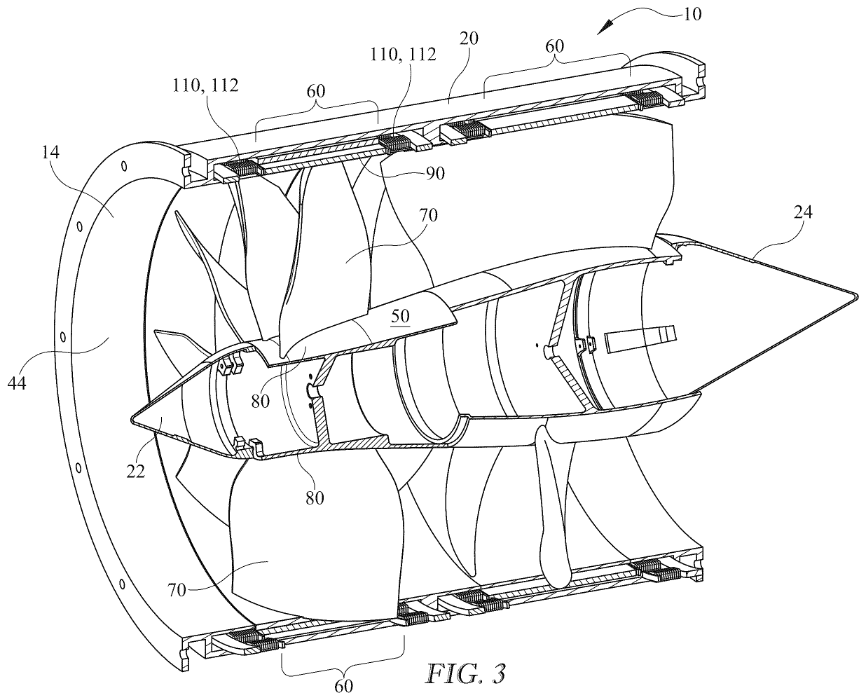

Referring now to the drawing Figures, and in particular FIGS. 1-4 and 21 an axial electromagnetic motor 10 in accordance with some aspects and embodiments suitable for use as an aircraft propulsion engine, is depicted. FIGS. 1 and 2 depict an exemplary axial electromagnetic motor 10 in perspective while FIGS. 3 and 21 provide a partial cross-sectional view to show the arrangement of portions of a motor 10 interior 12. It should be noted that throughout the specification the terms “air”, “gas”, or “fluid” will be used generally synonymously to refer to the flow of fluid through motor 10. As is known in the art motor 10 can comprise a stator case 20 into which entering air or fluid is directed, and nose 22 and tail 24 cones for directing the gas through interior 12 of motor 10. Stator case 20 is disposed at a forward portion 14 of motor 10, and is spaced circumferentially around nose cone 22 to direct air through a plurality of radially extending inlet struts 46 and guide vanes 48 that direct entering airflow through motor 10 toward an aft end 16 thereof.

Referring again to FIGS. 1-4 and FIG. 21, and in accordance with exemplary aspects and embodiments motor 10 may comprise a central axial shaft 30 that terminates in a diffuser or tail cone 24 that, in concert with a radially spaced nozzle acts to expand compressed airflow through aft portion 16 of the motor, thereby resulting in “jet” propulsion. A stator 40 comprises a stator cowl 42 that defines the exterior surface of the motor and it extends generally from an inlet case 44 to an exit guide vane case 46 and nozzle 26. Stator 40 may include inlet guide struts 46 that are secured at a radially outward end to stator cowl 42, and at a radially inward end to shaft 30. Similarly, a plurality of inlet guide vanes 48 may be fixedly secured between shaft 30 and inlet case 44. The guide vanes act to direct the working fluid through motor 10.

Referring now to FIGS. 1-4 and in accordance with exemplary embodiments a rotor 50 may include at least one rotating stage 60 extending radially between shaft 30 and stator case 20 that acts to pressurize the airflow through motor 10. In some embodiments rotor stage 60 may generally comprise a plurality of radial blades 70, extending between the interior of stator case 20 and shaft 30, each secured to a rotor wheel 80. Rotor wheel 80 is an inner ring disposed along a radially inward portion of blades 70 that is mounted for rotation on a bearing, or a plurality thereof, thereby permitting the rotor to rotate freely around shaft 30 thereby rotating blades 70 that are secured to wheel 80.

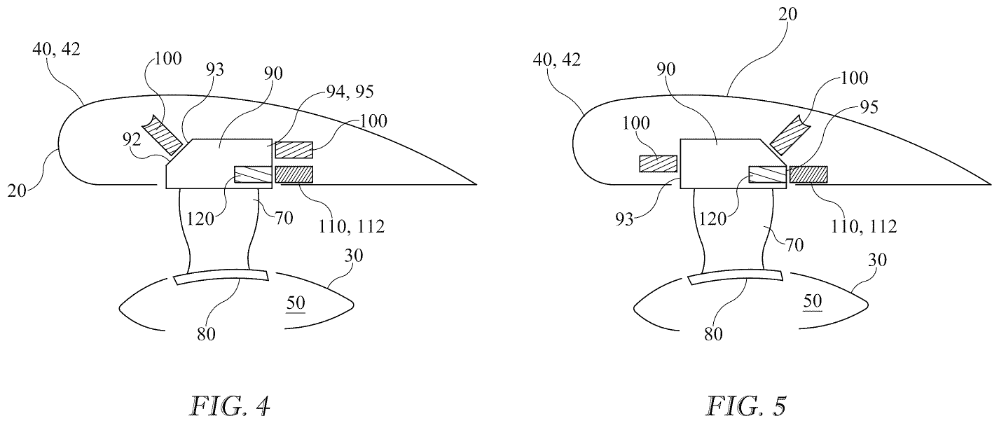

Blades 70 may terminate in, or in some exemplary embodiments be secured to a rotor outer ring 90 disposed proximate a radially outward portion of blades 70. In some embodiments blades 70 may be comprised of a non-metallic, non-conductive and non-magnetic material. Outer ring 90, as shown in FIG. 4, may include a forward face 92 having a forward face bearing surface 93 thereon and an aft face 94 also having an aft face bearing surface 95 thereon.

In some aspects and embodiments as depicted in, for example, FIGS. 1-5 motor 10 includes a plurality of bearings 100 disposed around and secured to stator case 20 in a plurality of interior locations, arranged to contact forward face 92 bearing surfaces 93 and the aft face 94 bearing surfaces 95 respectively. In these embodiments forward 93 and aft 95 face bearing surfaces respectively contact plurality of bearings 100 arranged around stator case 20 to lend stability to rotor 50 as it is driven, as will be discussed further herein below. Furthermore, as best depicted in FIGS. 3-16 for example, stator 40 includes at least one electromagnetic stator hoop 110 that is an annular hoop that is positioned around the inside of stator case 20 that includes a plurality of electromagnetic elements 112 disposed and secured around stator hoop 110.

A plurality of magnetic elements 120, for example permanent magnets, are similarly arranged and secured to rotor outer ring 90, at a plurality of points proximate to electromagnetic element 112 of stator hoop 110. Magnetic elements 120 may have their magnetic fields oriented parallel to the rotor's 50 axis of rotation and be located proximate electromagnetic elements 112 around stator hoop 110 so that electromagnetic elements 112 and magnetic elements 120 interact electromagnetically to drive rotor 50 around its axis, thus directing and compressing fluid flow through motor 10. The combination of stator hoop 110 and secured or affixed electromagnetic elements 112 may comprise an outer electromagnetic drive for operating motor 10 when elements 112 are operatively coupled to a source of electrical power as discussed further below.

In some embodiments, rotor 50 may be constructed to not utilize blades 70 at all, but instead include an outer ring 90 that includes a plurality of magnetic elements 120 that interacts with stator 40 hoop 110 electromagnetic elements 112. Stated another way, rotor 50 may comprise an outer ring 90 having magnetic elements 120 that is then driven by an outer electromagnetic drive comprised of stator hoop 110 and concomitant electromagnetic elements 112. In these embodiments rotor outer ring 90 may be adapted to, for example, drive a tire or transmission without the need for motor 10 to compress working fluid. It should be noted that the embodiments disclosed herein discuss the use of electromagnetic elements 120 and 112 of rotor 50 and stator 40, but the placement and interaction of the electromagnetic elements 120 and 112 can be used with any of various stages of a turbine engine arrangement, for example a bypass fan stage as discussed herein below, or a turbine stage, without departing from the scope of the embodiments disclosed herein.

In some aspects and embodiments, for example as depicted in FIGS. 7 and 9 rotor 50 blades 70, wheels 80, and outer ring 90 may be constructed as integrally bladed rotors wherein blades 70, inner ring or wheel 80, and outer ring 90 are all constructed as a unitary piece of material, thus providing stability and ease of assembly for rotor 50. In some embodiments the integrally bladed rotor 50 may include a variety of seals as is known in the art to aid in preventing the unwanted passage of air through the rotor assembly.

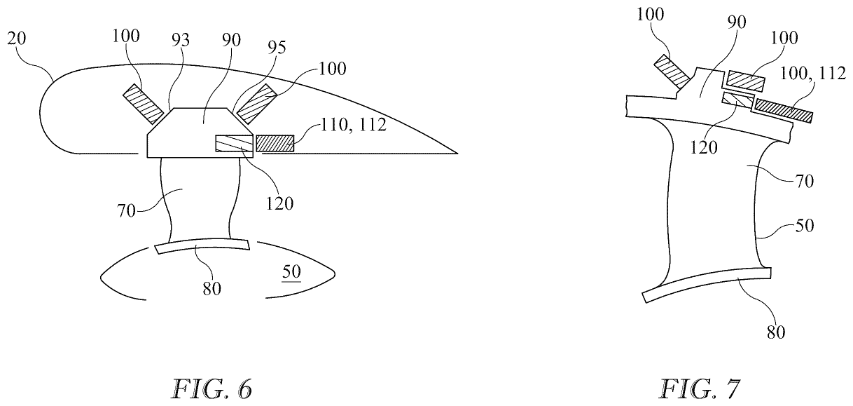

Referring again to FIG. 5, and in accordance with exemplary but non-limiting embodiments, rotor 50 may comprise a forward face bearing surfaces 93 that are generally flat on outer ring 90 forward face 92, while aft face 94 bearing surfaces 95 are beveled or angled on outer ring 90 aft face. Corresponding bearings 100 disposed on and secured to stator case 20 are then oriented so that they may engage both the flat forward face bearing surfaces 93 and beveled aft face bearing surfaces to guide the rotation of rotor 50. Similarly, the embodiments depicted in FIG. 6 show beveled bearing surfaces 93, 95 on both outer ring 90 forward face and aft face, with corresponding arrangements of stator case 20 bearings 100 oriented to engage the beveled bearing surfaces 93, 95.

FIG. 7 depicts yet another exemplary embodiment of rotor 50 having a beveled forward face bearing surface 93 located on outer ring 90 forward face 92 and a notched or recessed bearing surface 95 on outer ring 90 aft face 94. In this embodiment bearings 100 disposed on and secured to stator case 20 are oriented to engage corresponding beveled 93 and notched 95 bearing surfaces the outer ring 90. It should be noted that the exact orientation and location of bearings 100 and bearing surfaces 93, 95 on rotor blades 70 may be highly variable and tailored to specific rotor 50 embodiments depending upon the materials being used for stator 40 and rotor 50, rotating mass, rotational speed, temperature, and other operating characteristics of motor 10.

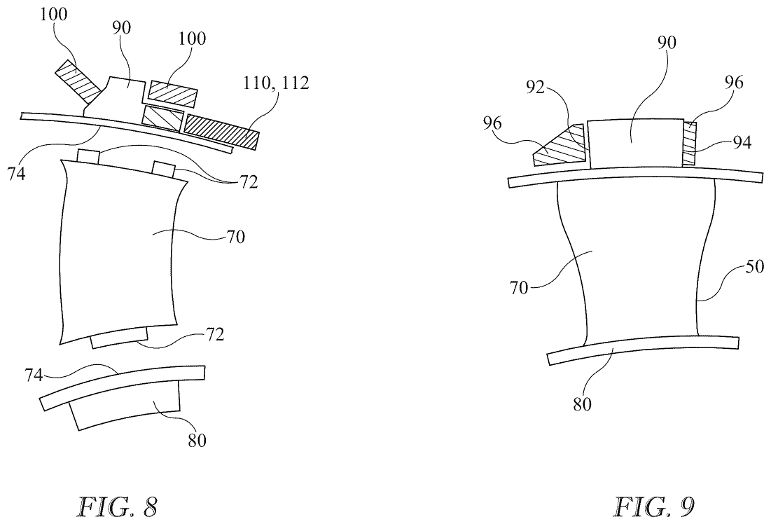

FIG. 8 depicts an embodiment of the motor wherein the rotor blades 70, inner ring 80, and outer ring 90 are all formed of separate, assembled pieces. It should be noted that each component, rings 80, 90 and blades 70, may be constructed of either metallic, non-metallic, conductive, non-conductive, magnetic, or non-magnetic materials in any combination without departing from the scope of the embodiments set forth in this specification. For example, blades 70 may be constructed of a metallic alloy, for example titanium, while inner 80 and outer 90 rings are formed of a non-metallic material such as a carbon fiber or a high strength polymer. Furthermore a wide variety of metallic and non-metallic materials may be used in the construction of rotor 50. In some embodiments blades 70 and rings 80, 90 may be constructed to engage each other with mating tabs 72 and slots 74 or equivalent structures to facilitate assembly of the rotor.

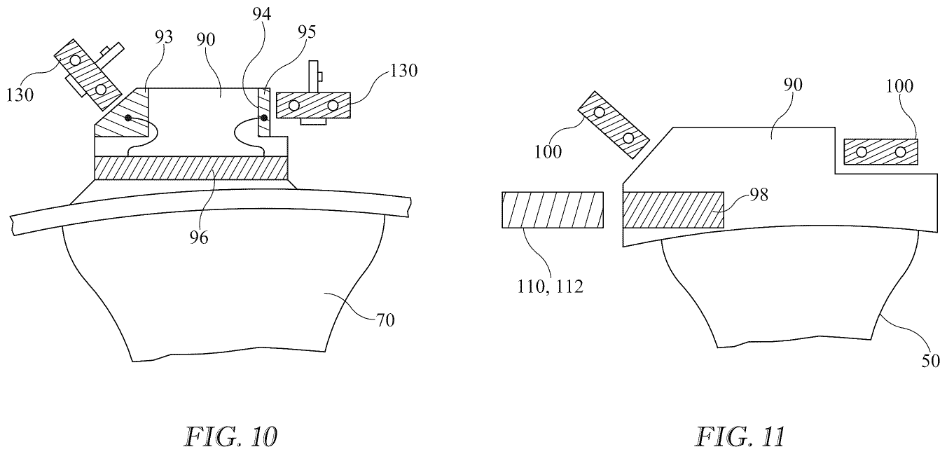

In accordance with some embodiments as best shown in FIGS. 9 and 10, rotor 50 may include an outer ring 90 formed of a non-conductive material, having a forward face 92 that includes a conductive bearing surface 93 secured thereto. In some aspects forward face 92 may comprise a beveled conductive metallic or non-metallic bearing surface 93 while aft face 94 may be a flat conductive metallic or non-metallic bearing surface 95. In these embodiments an electromagnet 96 (a magnetic element having a current-carrying coil arranged around its exterior that operates to generate an electromagnetic field), is positioned or disposed in or on outer ring 90. Corresponding electromagnetic elements 112 may be disposed on stator case 20 to provide electromagnetic engagement with the beveled and flat conductive forward 92 and aft 94 face elements 93, 95 respectively, thereby driving rotor 50 by electromagnetic interaction. Furthermore, in some aspects stator bearings 100 may be replaced by electromagnetic elements 112 such that an EM field is supplied through the contact of the electromagnetic elements 112 and the conductive forward and aft bearing faces 93, 95.

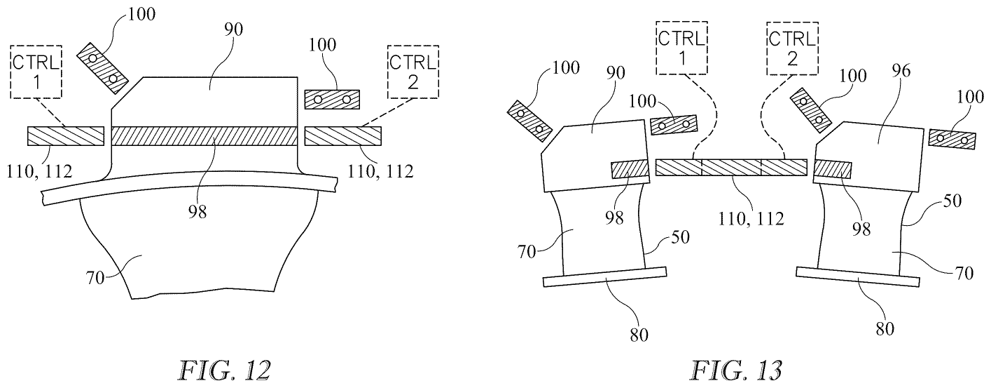

In some aspects and embodiments as depicted in FIGS. 11 and 12 motor 10 may include a rotor 50 that has a magnetic element 98 disposed in rotor 50 outer ring 90 and a corresponding stator hoop 110 that is disposed forward of the rotor stage having an electromagnetic element 112 spaced proximate magnetic element 98 of rotor 50 outer ring 90. In these embodiments stator electromagnetic element 112 interacts with rotor magnetic element 98 to drive rotor 50. Additionally and as shown in FIG. 12, a second stator hoop 110 located aft of rotor 50 is provided, also including an electromagnetic element 112, or a plurality thereof, disposed thereon and spaced proximate rotor magnetic element 98 such that both forward and aft stator hoop 110 electromagnetic elements 112 drive rotor 50. In these embodiments forward stator hoop 110 EM elements 112 and aft stator hoop 110 EM elements 112 may be separately controlled by individual controllers CTRL1, CTRL2 that have current outputs to energize and generate electromagnetic fields through electromagnetic elements 112, thereby providing for precise timing in the driving of rotor 50 and thus motor 10. In some embodiments segments or sections of electromagnetic element 112 groupings may be controlled together to generate the requisite EM field to drive rotor 50, as will be discussed herein below.

In yet further exemplary embodiments as depicted in FIG. 13, motor 10 may include at least two rotor 50 stages, each having a plurality of magnetic elements 98 disposed in forward and aft positions on outer rings 90 thereof, and at least one stator hoop 110 disposed between the rotor stages, stator hoop 110 having forward and aft sets of electromagnetic elements 112, or stator “teeth”, arranged around the circumference thereof. In some embodiments electromagnetic elements 112 on the stator hoop 110 may include separate EM coils that are electrically coupled to individual controllers CTRL1, CTRL2, for controlling the interaction with both forward and rear rotor 50 sections and concomitant magnetic elements 98 as necessary to drive rotor 50. In these embodiments the electromagnetic element 112 coils are advantageously controlled by separate three phase power controllers, as will be discussed herein below.

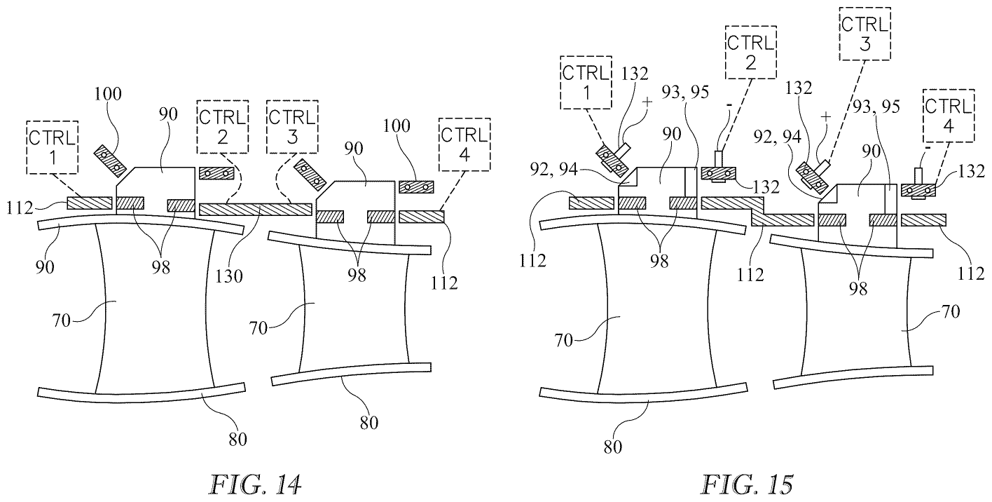

Referring now to FIG. 14 and in accordance with some embodiments, motor 10 rotor 50 may include a plurality of forward and aft stator hoops 110 and concomitant electromagnetic elements 112 disposed forward and aft of a rotor 50 stage or stages. In these embodiments a plurality of controllers CTRL1, CTRL2, CTRL3, CTRL4, may be operatively coupled to the plurality of forward and aft stator 50 EM elements 112 thereby providing electromagnetic interaction between rotor 50 and stator 40 sections of motor 10. FIG. 14, in on exemplary embodiment, depicts two rotor 50 stages and a series of four integrated controllers CTRL1, CTRL2, CTRL3, CTRL4 that provide timed current pulses to EM elements 112 at the forward and aft portions of the stator hoop 110 sections to drive rotor 50. It should be noted than any number of integrated controllers CTRLN may be utilized to operate motor 10 depending upon the number of rotor 50 and stator 40 stages included therein.

In further embodiments, for example those depicted in FIG. 15, each rotor 50 stage may include an outer ring 90 having a forward face 92 with an angled conductive bearing surface 93 secured thereto, as well as an aft face 94 having a conductive bearing surface 95 secured thereto. In these aspects the conductive bearing surfaces 93, 95 are electrically coupled to coils of a central electromagnetic element disposed in the outer ring of the rotor. Additionally, stator bearings may also be electromagnetic elements such that an EM field is supplied through the contact of the stator bearings and the conductive forward and aft bearing faces.

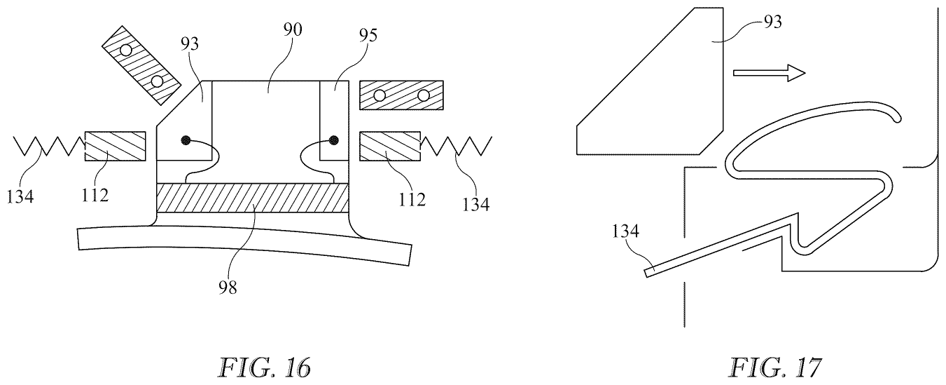

Referring now to FIGS. 13 and 14, and in accordance with certain embodiments the motor rotor may include an outer ring 90 having a forward face 92 with an angled conductive bearing surface 93 secured thereto, as well as an aft face 94 having a conductive bearing surface 95 secured thereto. Additionally, the conductive bearing surfaces 93, 95 are electromagnetically coupled to coils of electromagnetic elements 98 disposed in outer ring 90. A plurality of electrically conductive wipers 132 coupled to a current source, for example supplied by either a single phase or a three phase controller CTRL1, 2, 3, 4, are disposed around stator rings 110 at forward and aft locations, and positioned such that they contact the angled conductive bearing surfaces 93 on forward outer ring 90 face 92 and the conductive bearing surfaces 95 on aft outer ring 90 face 94. Conductive wipers 132 may be biased to contact the respective bearing surfaces 93, 95 by, for example, a spring or equivalent biasing mechanism. In other embodiments as shown in FIGS. 16 and 17 conductive bearing surfaces 93, 95 may be mounted or secured to a memory metal spring that biases conductive bearing surfaces 93, 95 away from rotor outer ring 90 so that bearing surfaces 93, 95 contact conductive wipers 132 on stator ring 110.

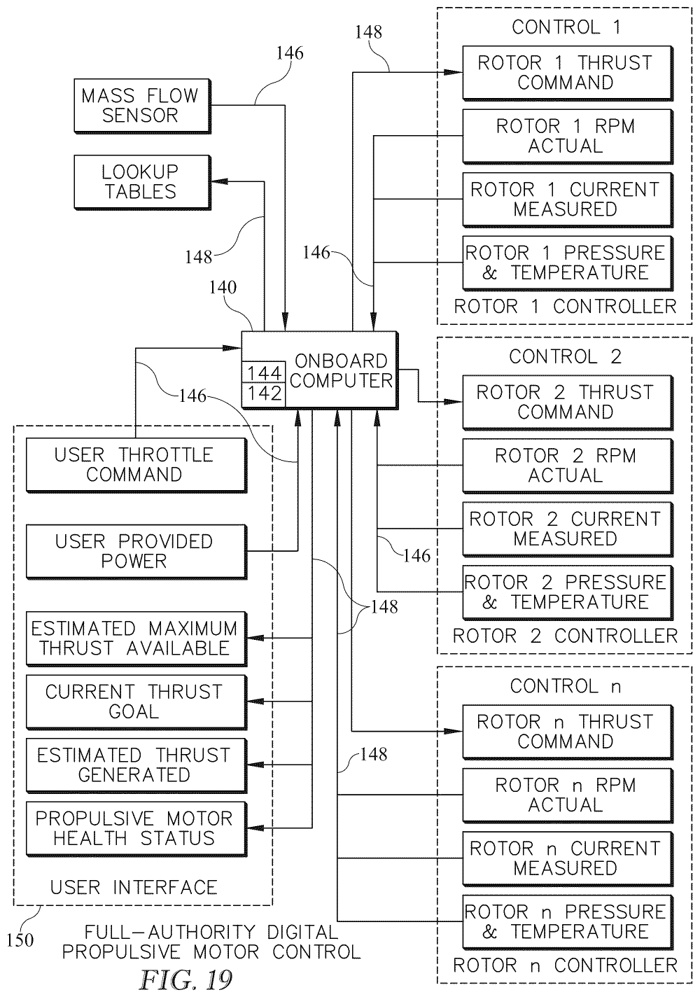

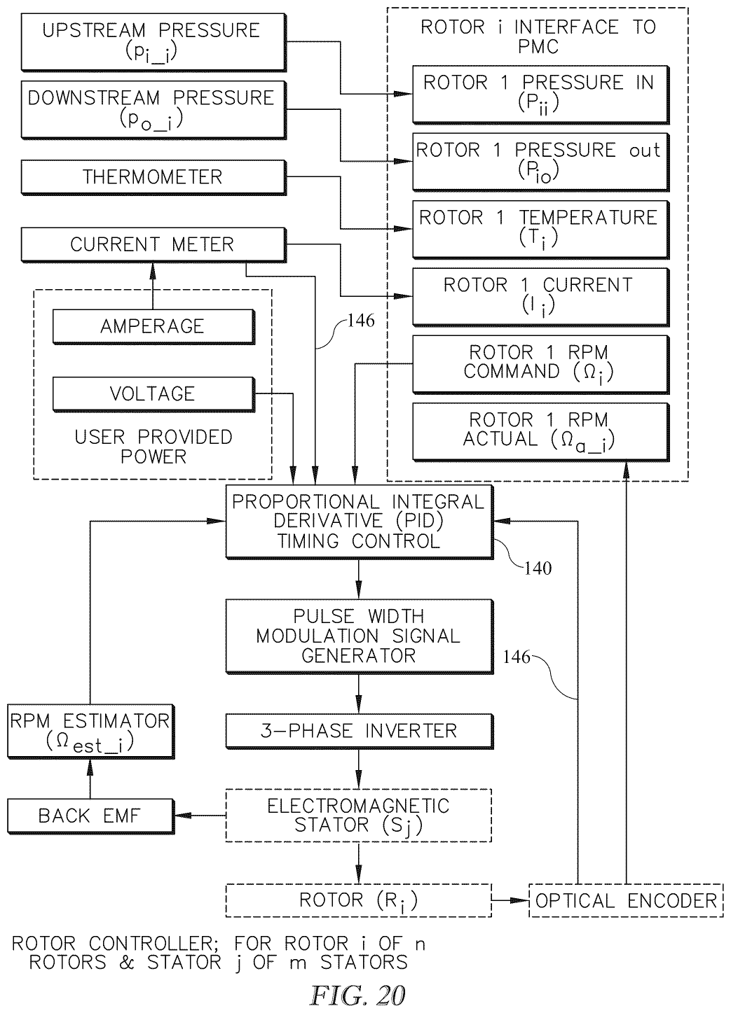

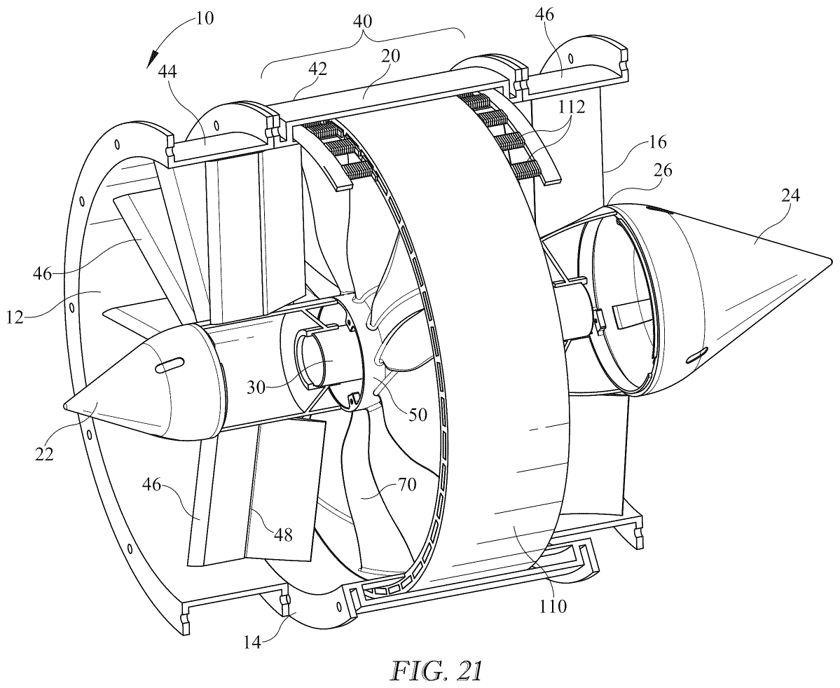

As depicted in FIGS. 19-20, and in accordance with some embodiments, motor 10, and more specifically the electromagnetic stator hoops 110 are controlled by a controller 140 having at least a processor 142, concomitant data memory 144, and a plurality of signal and power inputs and outputs 146, 148 respectively, that permit processor 140 to monitor, interact with and control various sensors and systems utilized to drive rotor 50 through electromagnetic interaction with stator 40. Additionally, a user interface 150 may be provided, that can be one of many known user interfaces such as a graphical user interface (GUI), a keyboard, a touch screen, or even a mobile computing platform such as a smart phone or tablet that is operatively coupled to controller 140. User interface 150 may display various motor 10 parameters and functions essential to its operation to a user, including but not limited to estimated maximum thrust, a current thrust setting or goal, estimated thrust generated, a throttle command or input, and motor health status that may in some embodiments monitor motor temperatures, vibrations at various locations, and sensor health according to various signal inputs 146 to controller 140.

In the embodiments shown in FIG. 95 a propulsive motor controller 140 includes a plurality of signal and power inputs 146 and outputs 148 for operating motor 10, including signal inputs 146 for a mass flow sensor for determining fluid flow through motor 10, a throttle command, rotor RPM, rotor current, rotor pressure, and rotor temperature for each rotor 50 stage in motor 10. Additionally, electrical power is provided to the controller to supply power through a plurality of outputs to the electromagnetic elements of each stator ring 110 as described herein above.

In some embodiments a plurality of rotor controllers CTRL1, CTRL2, . . . CTRLN are operatively coupled to controller 140 to actively control each rotor 50 stage, and thus the overall thrust output of motor 10, by executing a suitable instruction set stored in memory 144 to operate each rotor 50 stage utilizing the plurality of sensors their concomitant feedback as depicted in FIG. 20. Rotor controllers CTRL each include at least a plurality of sensors, for example an RPM (revolutions per minute) sensor, and current sensor, and at least one pressure and temperature sensor, each supplied as inputs 146 to controller 140 that permit controller 140 to monitor, interact with and control various sensors and systems utilized to drive rotor 50 through electromagnetic interaction with stator 40.

In some exemplary embodiments and aspects, controller 140 supplies a signal, for example a pulse-width modulated signal to each stator 40 section to control the electromagnetic elements 112 and thus the electromagnetic interaction between each stator 40 and rotor 50 section of motor 10, thereby rotating rotor 50 as the EM fields interact. A conventional encoder or RPM sensor may be operatively coupled to each rotor stage 50 to determine an actual rotor 50 speed in revolutions per minute (RPM) for example, and that speed is supplied as an input 146 to a feedback system operated by controller 140, that in some embodiments can be a PID (proportional-integral-derivative) control feedback system, as is known in electrical control system arts. An estimated rotor RPM is also supplied as an input 146 to controller 140 that is based on the stator EM field strength, and thus a resultant power output signal 148 is provided to stator 50 EM elements.

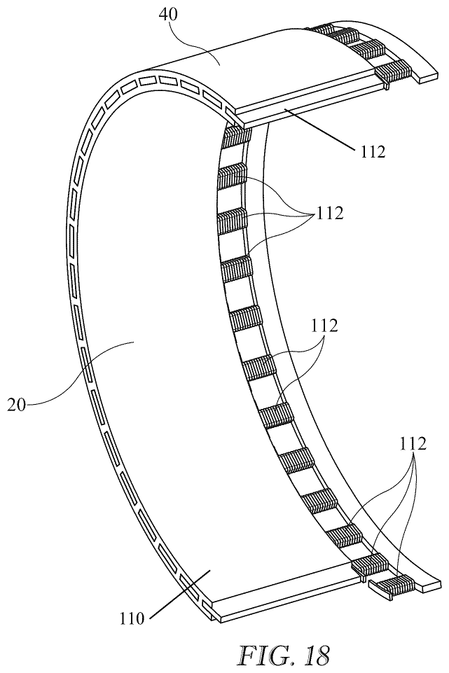

In accordance with some aspects and embodiments as depicted in FIG. 18 for example, for any stator 40 hoop 110 configuration stator hoops 110 may be configured into a plurality of arcuate segments 114 (arc segments), each having a plurality of EM elements 112 secured thereto. In some embodiments each segment 114 includes EM elements 112 in multiples of three, and these elements are controlled by three-phase windings operatively coupled to a three-phase controller CTRL operating according to the instructions set forth herein above. In some embodiments a plurality of data tables recording rotor 50 and stator 40 operating characteristics (rotational speed, temperature, pressure) may be provided in data memory accessible by controller 140 for setting motor 10 operating commands based on upstream and downstream ambient and motor 10 air pressures, air temperatures, rotor 50 pressures and temperatures, rotor 50 and stator 40 current, and of course actual and commanded speed of the various rotor 50 stages.

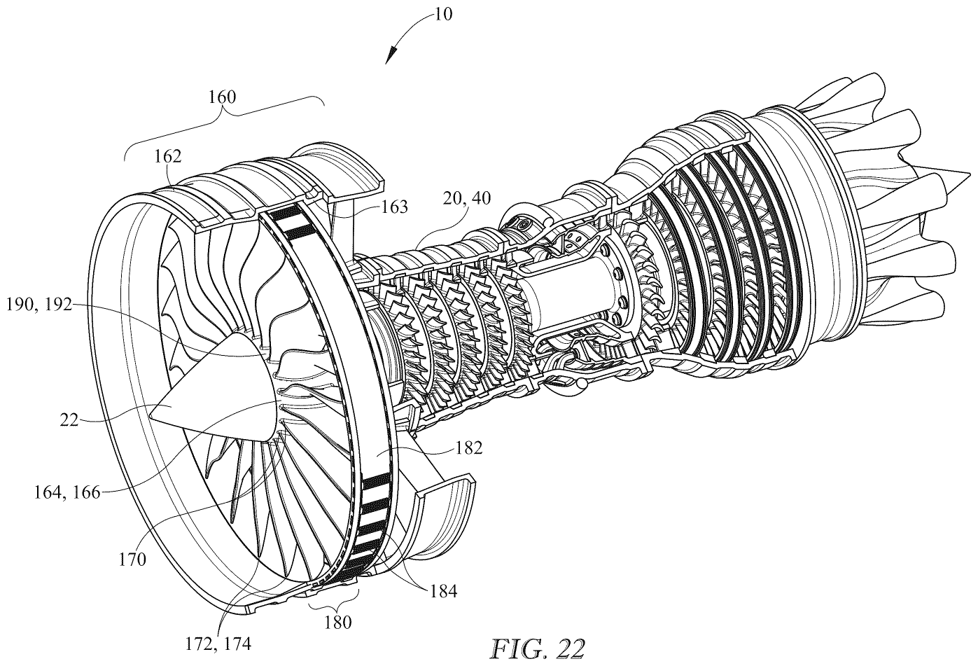

Referring now to FIG. 22, and in accordance with exemplary embodiments motor 10 can also include a bypass fan stage 160 located forward of stator 40. Bypass fan stage 160 may include a generally annular bypass duct 162 disposed circumferentially around a fan shaft 164 having a hub 166 rotatable around said shaft 164, and having a plurality of fan blades 168 secured to said hub 166 and extending radially outwardly to bypass duct 162. Fan blades 168 may extend radially between hub 166 at an radially inner end 170 and bypass duct 162 at a tip end 172, and are capable of rotation with hub 166 around shaft 164. Furthermore, fan blades 168 may incorporate magnetic or electromagnetic elements 174 in tip ends 172 similar to roto 50 blades 70 and wheels 90, or even in radially inner ends 170.

In these embodiments an outer electromagnetic drive 180 may be positioned to operate and rotate rotating fan blades 168. Outer electromagnetic drive 180 may include a fan hoop 182 that is disposed circumferentially around an interior portion 163 of bypass duct 162 having a plurality of electromagnetic elements 184 encased within hoop 182 proximate fan blade tip end 172 magnetic elements 174. In certain aspects plurality of electromagnetic elements 184 are disposed within bypass duct 162 hoop 182 whereby said fan blade 168 electromagnetic elements 174 and said bypass duct 162 electromagnetic elements 184 interact electromagnetically as fan blades 168 rotate. As in the rotor 40 embodiments discussed herein above a suitable fan controller CTRL1 may be operatively coupled to outer drive 180 and operatively coupled to controller 140 to actively control bypass fan stage 160.

Additionally, in some embodiments an inner electromagnetic drive 190 may be utilized with bypass fan stage 160 as well. Inner electromagnetic drive 190 may include a plurality of electromagnetic elements 192 secured around shaft that are positioned to interact with a plurality of electromagnetic elements 184 disposed in radially inner ends 170 of blades 168.

It should be noted that while the Figures and specification disclose motor temperatures and pressures, a wide variety of pressure and temperature sensors may be arrayed at a plurality of locations throughout the motor in various rotor and stator stage locations to monitor and control the operation of the motor in a wide variety of operating conditions. Furthermore, various current and voltage sensors and speed sensors for monitoring the operating characteristics of each rotor and stator stage, as well as the overall operating characteristics of the motor may be provided as signal inputs to the controller without departing from the scope of the disclosed embodiments.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

We claim:

1. An axial brushless motor and generator having a forward end and an aft end, and having a rotor capable of rotation around a shaft, and a stator having a case defining an exterior gas path of said motor from said forward end to said aft end, and a plurality of radially disposed vanes extending generally between said case frame and said shaft for directing a working fluid, comprising:
a plurality of blades radially disposed around said rotor for compressing said fluid having an outer ring disposed proximate a radially outward portion of said blades and an inner ring disposed proximate a radially inward portion of said blades, said blades comprised of a non-metallic, non-conductive, non-magnetic material, and said outer ring having a forward face having a bearing surface thereon and an aft face having a bearing surface thereon;
a plurality of magnetic elements secured to said outer ring having their magnetic fields oriented parallel to the axis of rotation of said rotor;
at least one electromagnetic stator hoop having a plurality of electromagnetic elements secured at a plurality of points around said hoop such that said electromagnetic elements of said stator hoop and said electromagnetic elements disposed in said outer ring electromagnetically interact to drive said rotor; and
a controller having a three phase power output to supply electrical power to said stator hoop electromagnetic elements.

2. The axial brushless motor of claim 1 comprising:
a plurality of magnetic elements secured to the aft face of rotor outer ring for interacting with said electromagnetic elements of said stator hoop.

3. The axial brushless motor of claim 1 comprising:
a plurality of magnetic elements secured to the forward face of rotor outer ring for interacting with said electromagnetic elements of said stator hoop.

4. The axial brushless motor of claim 1 comprising:
a plurality of blades having magnetic elements secured to an aft face and a forward face of their outer rings for interacting with said electromagnetic elements of said stator hoop.

5. The axial brushless motor of claim 4 wherein said blades, said inner ring and said outer ring are formed of a single piece of metallic non-magnetic material.

6. The axial brushless motor of claim 1 wherein said blades, said inner ring and said outer ring are formed of three separate pieces secured together, and wherein said blades, said inner ring and said outer ring may comprise a metallic or a non-metallic material.

7. The axial brushless motor of claim 1 wherein said a plurality of magnetic elements secured to said outer ring comprise:
conductive surface hoops secured to said outer ring forward and aft faces.

8. The axial brushless motor of claim 1 comprising:
an outer ring having an electromagnetic element disposed therein extending between said forward and aft faces.

9. The axial brushless motor of claim 8 comprising:
a plurality of electromagnetic elements secured at a plurality of points around said stator hoop such that said electromagnetic elements of said stator hoop and said magnetic elements disposed in said rotor blade outer ring electromagnetically interact to drive said rotor.

10. The axial brushless motor of claim 7 comprising:
an electromagnet disposed in said outer ring having coil leads electrically coupled to said forward and aft face surface hoops.

11. The axial brushless motor of claim 1 comprising:
a stator disposed forward of said rotor and having at least one electromagnetic element proximate said magnetic elements of said rotor outer ring.

12. The axial brushless motor of claim 1 comprising:
a first electromagnetic stator hoop having a plurality of electromagnetic elements secured at a plurality of points around said hoop disposed forward of said outer ring; and
a second electromagnetic stator hoop having a plurality of electromagnetic elements secured at a plurality of points around said hoop disposed aft of said outer ring.

13. The axial brushless motor of claim 1 comprising:
at least two rotor stages; and
an electromagnetic stator hoop disposed between said at least two rotor stages, said stator hoop having forward and aft electromagnetic elements secured thereon for magnetically engaging magnetic elements in said at least two rotor stages.

14. The axial brushless motor of claim 1 comprising:
a plurality of rotor stages; and
an electromagnetic stator hoop disposed forward of a forward most rotor stage, said stator hoop having an electromagnetic element secured thereon for magnetically engaging magnetic elements in said forward most rotor stage and;
a plurality of electromagnetic stator hoops disposed between each of said plurality of rotor stages, said stator hoops having forward and aft electromagnetic elements secured thereon for magnetically engaging magnetic elements in said plurality of rotor stages.

15. The axial brushless motor of claim 14 comprising:
an electromagnet disposed in said outer ring having coil leads electrically coupled to said forward and aft face surface hoops.

16. The axial brushless motor of claim 15 comprising;
each rotor having an outer ring having a forward face having an angled conductive bearing surface thereon and an aft face having a conductive bearing surface thereon; and
a plurality of electrically conductive wipers coupled to a source of electrical power for contacting said conductive bearing surfaces of said rotors.

17. An electromagnetic propulsive motor as claimed in claim 1 comprising:
a controller having a plurality of inputs and outputs, said outputs operatively connected to said windings of said electromagnetic elements for providing an electrical signal to said windings, thereby producing an electromagnetic field in said elements.

18. An electromagnetic propulsive motor as claimed in claim 1 comprising:
a stator case frame housing for encasing a plurality of electromagnetic elements radially outwardly from said rotor blades.

19. An electromagnetic propulsive motor as claimed in claim 1 comprising:
an aft electromagnetic drive housing; and
a plurality of electromagnetic elements positioned within said aft drive housing, wherein said aft drive housing is proximate the radially outward point of said rotor blades, and wherein said aft drive housing electromagnetic elements interact with said rotor blade electromagnetic elements.

20. An electromagnetic propulsive motor as claimed in claim 1 having a bypass fan stage forward of said stator, and having a bypass duct disposed circumferentially around said bypass fan stage and a fan shaft having a hub rotatable around said shaft comprising:
a plurality of fan blades extending radially between said hub at an inner end and said bypass duct at a tip end, and capable of rotation with said hub; and
an outer electromagnetic drive for rotating said fan blades.

21. An electromagnetic propulsive motor as claimed in claim 20 comprising:
an inner electromagnetic drive for rotating said fan blades.

22. An electromagnetic propulsive motor as claimed in claim 20 wherein said outer electromagnetic drive comprises:
a plurality of electromagnetic elements encased within said fan blades proximate said tip portions thereof; and
a plurality of electromagnetic elements disposed within said bypass duct whereby said fan blade electromagnetic elements and said bypass duct electromagnetic elements interact electromagnetically to rotate said fan blades.

23. An electromagnetic propulsive motor as claimed in claim 1 comprising:
a monolithic rotor formed of a single piece of material having a rotor wheel journaled for rotation around said shaft, wherein said monolithic rotor comprises said rotor wheel, said rotor blades, and an annular rotor hoop extending around an external circumference of said rotor.

24. An axial brushless motor and generator having a forward end and an aft end, and having a rotor capable of rotation around a shaft, and a stator having a case defining an exterior gas path of said motor from said forward end to said aft end, and a plurality of radially disposed vanes extending generally between said case frame and said shaft for directing a working fluid, comprising:
an outer ring disposed proximate a radially outward portion of said rotor having a plurality of magnetic elements secured thereto having their magnetic fields oriented parallel to the axis of rotation of said rotor;
an outer electromagnetic drive positioned around a circumference of said stator, having at least one stator hoop and a plurality of electromagnetic elements secured thereto; and
a controller having a three phase power output to supply electrical power to said stator hoop electromagnetic elements and thereby drive said rotor.
